(19) United States
(12) Patent Application Publication
(10) Pub. No.: US 2009/0049106 A1
(43) Pub. Date: Feb. 19, 2009

(54) Method To Improve Collaboration Within An Organization

(75) Inventors: Vijay BOMMIREDDIPALLI, San Jose, CA (US); Samuel Hoi Ki WONG, San Jose, CA (US); Rakesh Ranjan, San Jose, CA (US); Rupesh Kartha, San Jose, CA (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/839,491

(22) Filed: Aug. 15, 2007

(51) Int. Cl. G06F 17/30

(52) U.S. Cl. 707/201; 707/E17.038

(57) ABSTRACT

A system and method in accordance with the present invention provides a composite chart of interpersonal relationships of members within an organization. A user can utilize the composite chart to identify persons of interest or the effective organization based on any context or multiple contexts both internally and externally to the organization.

### FIELD OF THE INVENTION

The present invention relates generally to organizational charts and in particular to a system for improving collaboration within an organization.

### BACKGROUND OF THE INVENTION

For corporations which offer a wide variety of products and services, cross-organizational collaboration and employee skill set searches are essential for corporations to compete in a global marketplace. Typically, the task of cross organizational collaboration includes utilizing employees' interpersonal relationships and dotted line connections from a mass employee base and engaging them to work on a joint project. The task of identifying these connections may become more challenging when organizations span across national boundaries and into international geographies.

The methods used today to address the aforementioned challenges are purely text oriented and difficult to use. More importantly, these methods are typically limited to conventional organizational charts.

Thus, what is needed is a system and method that addresses the above-identified issues. The present invention addresses such a need.

### SUMMARY OF THE INVENTION

A system and method in accordance with the present invention provides a composite chart of the conventional organizational chart superimposed with additional layers of relationships of members of that organization, with others within or outside the organization. A user can utilize the composite chart to identify employees that have inherent relationships relevant to the context of the search, internally and externally to the organization.

### BRIEF DESCRIPTION OF SEVERAL VIEWS OF THE DRAWINGS

FIG. 1 shows a flowchart of a method for creating the composite chart that shows the organizational layer and a non-organizational layer (for e.g. interpersonal relationships of members) within an organization.

FIG. 2 shows a base layer, which includes an organizational chart.

FIG. 3 shows a paradigm layer, which includes contacts to employees within the organization.

FIG. 4 shows the paradigm layer superimposed on the base layer.

### DETAILED DESCRIPTION OF THE INVENTION

The present invention relates generally to organization charts and in particular to a system for improving collaboration within an organization. The following description is presented to enable one having ordinary skill in the art to make and use the embodiment and is provided in the context of a patent application and the generic principles and features described herein will be apparent to those skilled in the art. Thus, the present embodiment is not intended to be limited to the embodiments shown, but is to be accorded the widest scope consistent with the principles and features described herein.

A system and method in accordance with the present invention includes a composite chart of members within an organization and one or more superimposed layers containing another set of relationships, which originate from or point to, members of the base layer. The relationships in those layers could be based on whatever is contextually relevant to the layer. A user can utilize the composite chart to identify employees of interest internally and externally to the organization.

For example, a person within the U.S. may need to identify an individual with sales, development, and marketing experience in a particular foreign country. The employee may utilize a system and method in accordance with the present invention to utilize business contacts within a corporation to extend the search. Particularly, the person may superimpose a layer, which plots the business contacts of the employees within the corporation on a base organizational layer.

The superimposition of the two layers provides a new organizational chart, which helps identify a set of employees that have inherent relationships relevant to the context of the search. Moreover, this method helps uncover hidden relationships amongst employees that extend beyond conventional organizational charts (“org charts”). A user that utilizes a composite chart of the present invention can visualize the effective network of an organization and will be able to collaborate across the organization without a restricted view based upon functional groups or geographies within. As such, utilizing the composite chart enables strong collaboration.

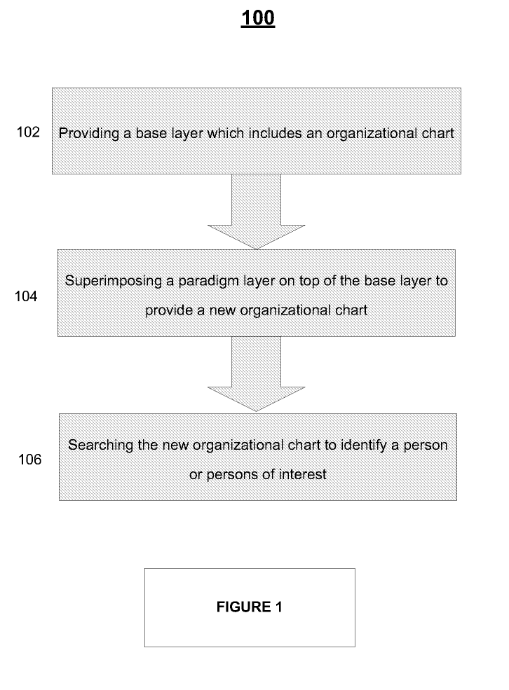

FIG. 1 shows a flowchart 100 of a method for depicting interpersonal relationships of members within and external to an organization, as an example application of this method. The method begins, via step 102, by providing a base layer which includes an organizational chart. Base layer includes employees, which may be organized according to employee rank.

Next, a paradigm layer is superimposed on the base layer to provide a new organizational chart, via step 104. The paradigm layer includes contacts to employees within the base layer and couples to the base layer by a variety of modes, as provided in detail below.

Once the new organizational chart is provided, a user can search through the chart to identify a person or persons of interest, via step 106. As such, the user can identify key personnel within the organization, which has as few as one degree of separation from employees within the base layer. To describe the features of the present invention in more detail, refer now to the following description in conjunction with the accompanying figures.

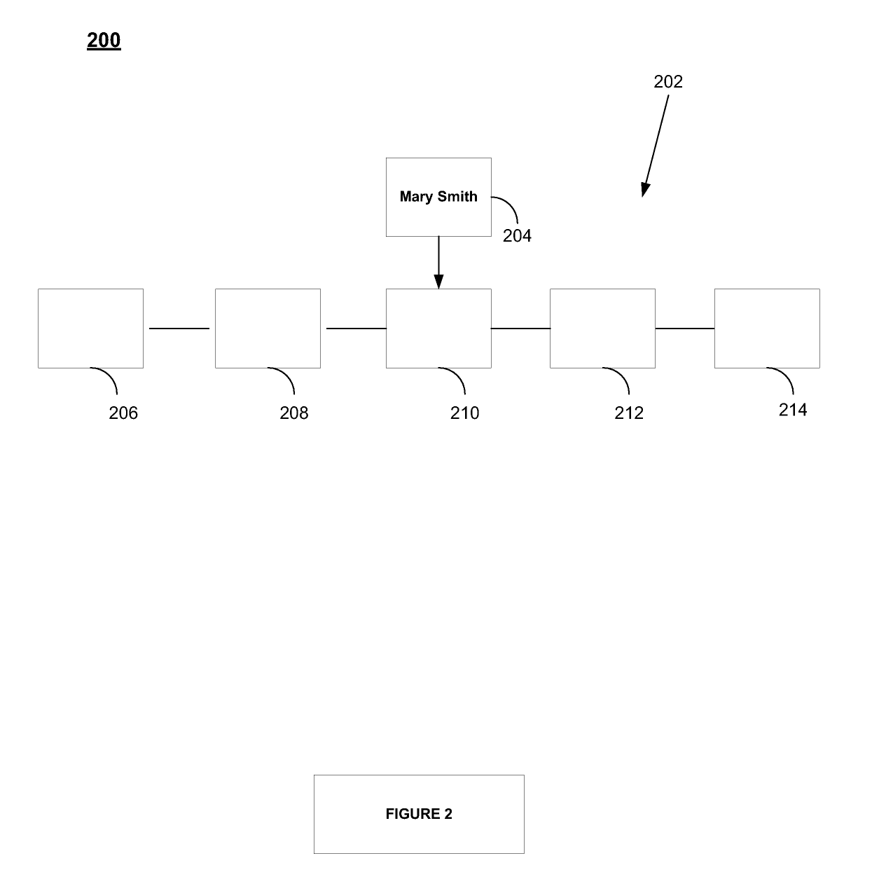

FIG. 2 shows a base layer 200, which includes an organizational chart 202. As shown, organizational chart 202 includes employees, represented by blocks 204, 206, 208, 210, 212, and 214. For an embodiment, each block represents one member within an organization. For example, block 204 is representative of employee Mary Smith. Base layer 200 may include the organizational chart 202 that is organized by rank. For example, Mary Smith has authority over the employees (206, 208, 210, 212, and 214), as shown in organizational chart 202.

For an alternative embodiment, base layer 200 only includes members within a division or department within an organization. Thus, the base layer 202 may represent members within a group, team, department, division, entire organization, and the like would be within the spirit and scope of the present invention.

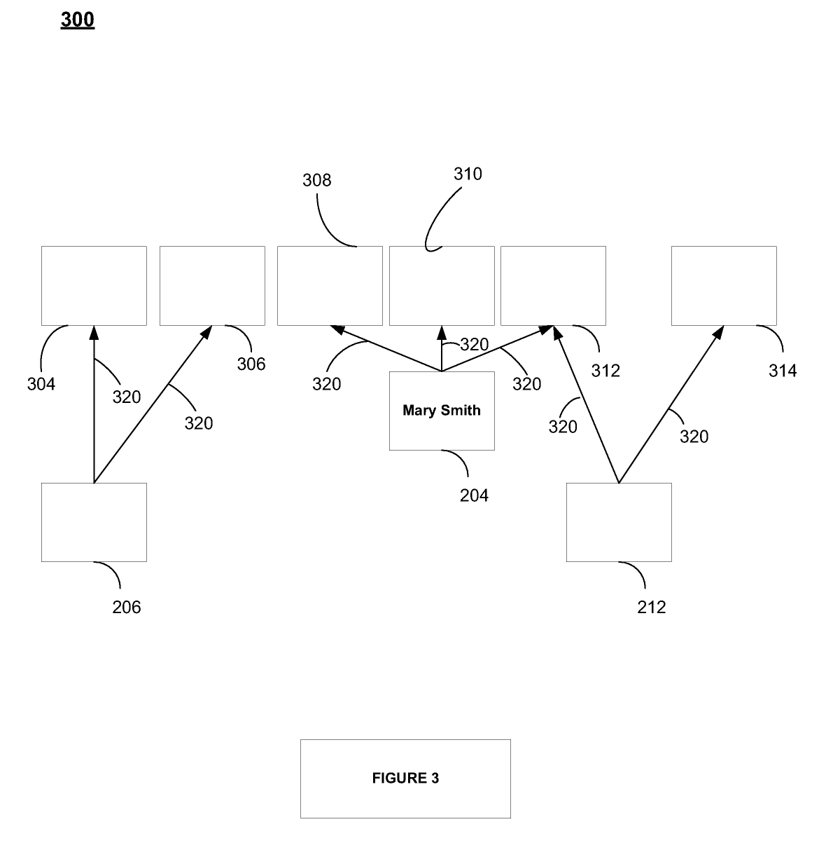

FIG. 3 shows a paradigm layer 300 which includes contacts (represented by blocks 304, 306, 308, 310, 312, and 314) to employees (blocks 204, 206, and 212) within an organization. The employees and contacts are coupled together via anchors 320. Each employee (blocks 204, 206, of 212) and corresponding employee contact(s) (blocks 304, 306, 308, 310, 312, and 314, respectively) have a common relationship within the paradigm layer 300. For an embodiment, the common relationship of an employee and employee contact throughout the paradigm layer 300 characterizes the paradigm layer. For example, within paradigm layer 300, employee (block 206) and employee contacts (blocks 304 and 306) may be college buddies, employee (block 204) and employee contacts (blocks 308, 310, and 312) may have been roommates their freshmen year of college, and employee (block 212) and employee contacts (blocks 312 and 314) may have been partners assigned to an engineering project in college. Accordingly, the commonality of relationships within this example is best characterized by “college contacts”. As such, an employee within a corporation may utilize this paradigm when searching for professionals within an organization to serve as college recruiters.

For an embodiment, at least one of the employee contacts (blocks 304, 306, 308, 310, 312, and 314) within the paradigm layer 300 are co-employees of employees (blocks 204, 206, and 212) within the same corporation. This may occur when the base layer 200 includes an organizational chart of a single group or division within a corporation.

For example, if the base layer includes an organizational chart of an engineering department within an organization, a paradigm layer may represent a group of marketing contacts to the employees within the base layer. The marketing contacts to the employees may include members of a marketing department within the corporation and accordingly, these employees may be identified within the paradigm layer.

The paradigm layer 300 may include a professional guild or society, email distribution list, college contacts, members of a fraternity and sorority, country club members, and the like would all be within the spirit and scope of the present invention.

Additionally, generating the paradigm layer 300 may include any of a group of techniques including professional network analysis, social network analysis, common interests, a social bookmark technique, and the like would all be within the spirit and scope of the present invention.

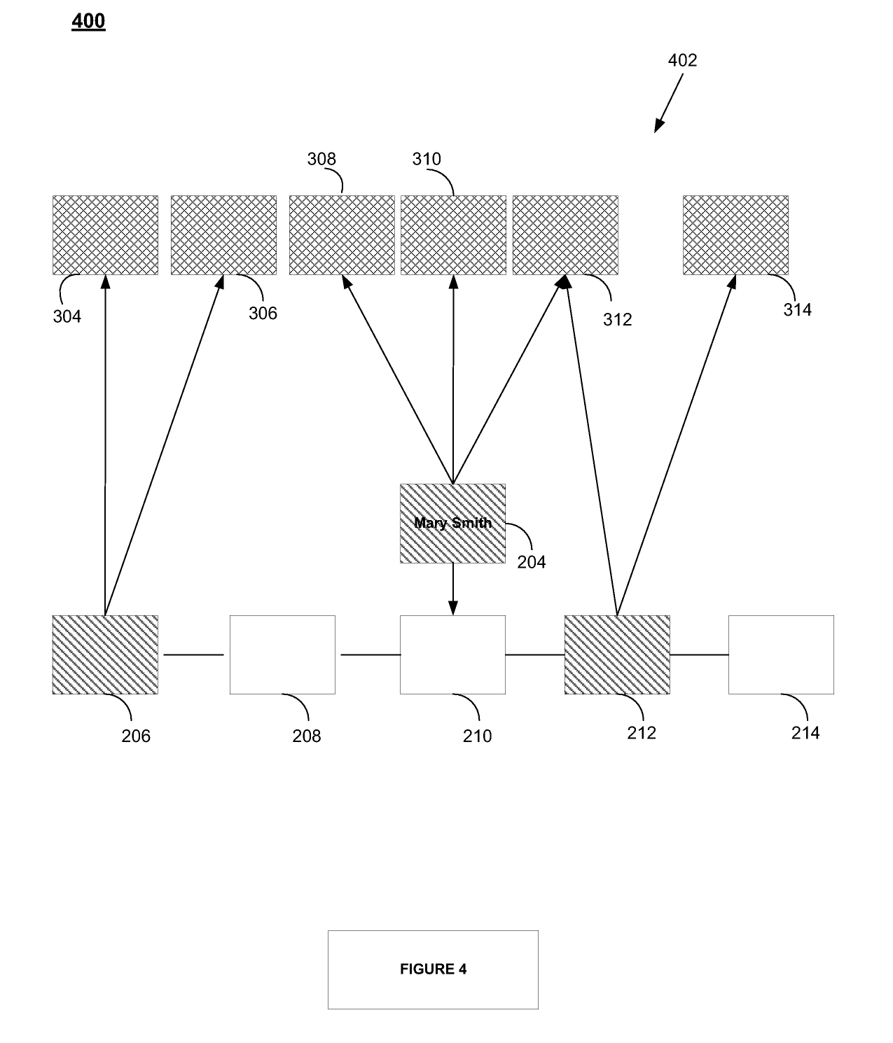

FIG. 4 shows the paradigm layer 300 superimposed on the base layer 200. For an embodiment, the superimposition of the paradigm layer 300 and the base layer 200 is a hybrid base/paradigm layer 400, which includes a new organizational chart 402.

Now referring to FIGS. 2 and 3 together, paradigm layer 300 is shown superimposed on the base layer 200, within the new organizational chart 402. For an embodiment, the new organizational chart 402 is a composite chart of an organization. As shown, the new organizational chart 402 includes employees (blocks 204, 206, 208, 210, 212, and 214) and employee contacts (blocks 304, 306, 308, 310, 312, and 314). The blocks shown in FIG. 4 have unique shadings to indicate whether the person is an employee, an employee with contacts, or a contact of an employee.

The paradigm layer 300 may be superimposed on the base layer 200 by a variety of methods. For example, the paradigm layer 300 and the base layer 200 may be superimposed upon each other by manually placing a first transparent plastic sheet, on which the base layer 200 is disposed, over a second transparent plastic sheet, on which the paradigm layer 300 is disposed.

Another example includes utilizing computer software to virtually superimpose the paradigm layer 300 on the base layer 200. The computer software may include any graphing tool, which can be utilized to show connections between employees and employee contacts within the new organizational chart 402. The graphing tool may continue to display individual images of the base layer 200 and the paradigm layer(s) 300 as a user alterable state change of the graph from the composite view layer (402).

When the paradigm layer 300 is superimposed on the base layer 200, the paradigm layer 300 is coupled to the base layer 200 via an anchor 320 from at least one employee (blocks 204, 206, 208, 210, 212, or 214) on the base layer 200 to at least one employee contact (blocks 304, 306, 308, 310, 312, and 314) on the paradigm layer 300.

There may be a plurality of paradigm layers within the new organizational chart 402. For example, new organizational chart 402 may include a base layer and two paradigm layers (first and second paradigm layers). The first paradigm layer may be superimposed upon the base layer and the second paradigm layer may be superimposed over the first paradigm layer. Thus, a plurality of paradigm layers may be incorporated within the new organizational chart 402 by superimposing each additional paradigm layer successively over each other.

For an embodiment, each additional paradigm layer within the new organizational chart 402 is coupled to the base layer via an anchor from at least one employee contact on the additional paradigm layers to at least one employee on the base layer. Thus, the new organizational chart 402 may have multiple paradigm layers therein, all coupled to the base layer. Hence, according to the embodiment, there is a one degree of separation between at least one employee on the base layer and at least one employee contact on each paradigm layer. For example, if there are one hundred paradigm layers within the new organizational chart 402, there is at least one connection from each paradigm layer to the base layer, such that there are at least one hundred connections to the base layer within the new organizational chart 402.

For an alternative embodiment, each additional paradigm layer is incorporated within the new organizational chart 402 by superimposing each additional paradigm layer successively upon each other. Furthermore, each successive paradigm layer is coupled to an adjoining paradigm layer via an anchor that couples at least one employee contact from each additional paradigm layer. Thus, this model of the new organizational chart 402 provides a degree of separation greater than one and may be utilized within a new organizational chart 402.

Within the new organizational chart 402, there may be multiple employees within the base layer that has direct connections to the same employee contacts on the paradigm layers. Thus, the employees on the base layer may have identical employee contacts. For example, FIG. 4 shows that employees (blocks 204 and 212) share the same contact to employee contact (312).

Accordingly, a system and method in accordance with the present invention includes a composite chart of interpersonal relationships of members within an organization. A user can utilize the composite chart to identify key personnel and identify business and social contacts of employees within an organization or simply identify the effective organization based on the context of the additional layers.

Although the present embodiment has been described in accordance with the embodiments shown, one having ordinary skill in the art will readily recognize that there could be variations to the embodiments and those variations would be within the spirit and scope of the present embodiment. Accordingly, many modifications may be made by one having ordinary skill in the art without departing from the spirit and scope of the appended claims.

What is claimed is:

1. A method for extracting interpersonal relationships of employees within a corporation comprising:
providing a first layer which includes an organizational chart of a group of employees and a ranking of the group of employees within the corporation; and
superimposing at least one second layer on the first layer to provide a new organizational chart, wherein the at least one second layer is contextually relevant to a search, the at least one second layer having a group of employee contacts, the at least one second layer coupling the first layer via an anchor from at least one employee on the first layer to at least one employee contact on the at least one second layer, wherein the at least one second layer is characterized by a common relationship between an employee and an employee contact in the new organizational chart, wherein the new organizational chart can be searched to identify an individual of interest.

2. The method of claim 1, further comprising providing the at least one second layer by utilizing any and any combination of a group of techniques.

3. The method of claim 2, wherein the group of techniques include a professional network analysis, a social network analysis, a set of common interests, and a social bookmark technique.

4. The method of claim 1, wherein superimposing the at least one second layer on the first layer includes any of utilizing a computer software or placing a first transparent plastic sheet, on which the first layer is disposed on a second transparent plastic sheet, on which the at least one second layer is disposed.

5. A composite chart of interpersonal relationships of employees within a corporation comprising:
a base layer which includes an organizational chart of a group of employees and a ranking of the group of employees within a corporation; and
at least one paradigm layer having a group of employee contacts, the at least one paradigm layer is superimposed on the base layer to provide a new organizational chart, wherein the at least one paradigm layer is contextually relevant to a search, the at least one paradigm layer is coupled to the base layer via an anchor from at least one employee on the base layer to at least one employee contact on the at least one paradigm layer, wherein the paradigm layer is characterized by a common relationship between an employee and an employee contact in the new organizational chart.

6. The composite chart of claim 5, wherein the at least one paradigm layer may include any of a professional guild, a professional society, an email distribution list, college contacts, fraternity members, sorority members, and members of a country club.

7. The composite chart of claim 5, wherein the base layer is disposed on a first transparent plastic sheet and the at least one paradigm layer is disposed on a second transparent plastic sheet.

8. A composite chart of interpersonal relationships of employees within a corporation comprising:
a base layer which includes an organizational chart of a group of employees and a ranking of the group of employees within a corporation; and
at least one paradigm layer having a group of employee contacts, the at least one paradigm layer is provided by utilizing any and any combination of group of techniques including professional network analysis, social network analysis, common interests, and a social bookmark technique, the at least one paradigm layer is superimposed on the base layer to provide a new organizational chart, wherein the at least one paradigm layer is contextually relevant to a search, the at least one paradigm layer is coupled to the base layer via an anchor from at least one employee on the base layer to at least one employee contact on the at least one paradigm layer, wherein the paradigm layer is characterized by a common relationship between an employee and an employee contact in the new organizational chart, and wherein there is at least one degree of separation from each employee on the base layer and each employee contact on the at least one paradigm layer.
